(19) United States
(12) Patent Application Publication
(10) Pub. No.: US 2002/0077265 A1
(43) Pub. Date: Jun. 20, 2002

(54) Laundry articles and methods for care of fabrics or combined cleaning and care of fabrics

(76) Inventors: Francesco de Buzzacarini, Breendonk (BE); Karel Jozef Maria Depoot, Waregem (BE); Diane Parry, Cincinnati, OH (US); James Charles Burckett St. Laurent, Lasne (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/949,954

(22) Filed: Sep. 10, 2001

Related U.S. Application Data
(60) Provisional application No. 60/278,126, filed on Mar. 23, 2001.
(60) Provisional application No. 60/231,901, filed on Sep. 11, 2000.

(51) Int. Cl. C11D 17/00

(52) U.S. Cl. 510/296

(57) ABSTRACT

Laundry articles for care of fabrics or combined cleaning and care of fabrics and methods of use of such articles. Multi-compartment containers combined with selected fabric laundering compositions that comprise selected care agents in different compartments or a selected cleaning agent in one compartment and a selected care agent in another compartment. On combining the compositions from the multi-compartment containers, preferred articles provide heavy duty liquid laundry detergents having fabric care benefits.

### CROSS-REFERENCE TO RELATED APPLICATION

This patent application claims the benefit of U.S. Provisional Application Serial No. 60/278,126 filed Mar. 23, 2001 by Buzzaccarini et al. and U.S. Provisional Application Serial No. 60/231,901 filed Sep. 11, 2000 by Buzzaccarini et al.

### FIELD OF THE INVENTION

The present invention relates to laundry articles for the care of fabrics and to methods of their use. The articles comprise multi-compartment containers combined with selected fabric laundering compositions. At least one composition, in one compartment of the container, comprises a selected essential fabric care active. Preferably, a second composition, in another compartment of the container, comprises a selected fabric cleaning agent.

### BACKGROUND OF THE INVENTION

For many years, efforts were made to integrate into a single package several fabric care ingredients or to integrate fabric cleaning ingredients, such as surfactants, with (ii) fabric care ingredients, such as fabric softeners of the saturated di-long chain dimethylammonium quaternary type. The art is replete with teachings on how to make such “two-in-one” products. Such products can result in a compromise of cleaning and fabric softening performance, and tend to have stability or compatibility issues. On the other hand, such integrated products are cheap to produce and tend to involve inexpensive packaging.

In certain fields of art, not necessarily related to the field of the present invention which is especially concerned with washing clothing, e.g., in an automatic washing-machine, there has also been work directed in the opposite direction, keeping components separated until the point of use. This is, for example, the case with the field of contact lens cleaners. The separation of components is useful to store chemically reactive materials apart from one another until they need to be combined and used.

Also known in general are kits comprising different kinds of surface (e.g., hair) treatment products, such as are used in conjunction with washing, bleaching and/or coloring of hair. One utility of such a kit is to direct the consumer to use certain compositions together, even though the compositions may be independently complete and useful.

In yet another area of the art, there have been developments in washing appliances, in which, for example, sophisticated dosing systems involving separate storage of multiple separate components, e.g., four or more, can be used to make it possible to combine multiple separately stored ingredients when they are needed for cleaning-related purposes. However such an approach involves cost, creates technical complexity, and raises issues of appliance reliability. Moreover consumers do not necessarily want to be obliged to replace their washing machines with new ones having complex and unreliable dosing systems in order to secure certain technical benefits during the laundering process.

All of these developments leave much to be achieved technically and for consumer satisfaction in the laundry field. For example, modern consumers desire uncomplicated yet effective ways to secure new benefits in the laundry, such as an improved ability to conduct both (a) cleaning of the laundry and (b) treatment thereof with unconventional or recently developed fabric care ingredients, more particularly, fabric care actives which differ from the historical non-biodegradable quaternary fabric softeners. Furthermore, for many consumers, laundering their clothes is fundamentally an onerous chore. It would be desirable to increase consumer enjoyment and satisfaction when such chores must inevitably be done.

A number of contexts have now been discovered and investigated in which novel articles as defined hereinafter are useful and solve significant technical problems.

In a first mode or context, it is found to be unexpectedly advantageous for reasons of storage stability and incompatibility, to separate certain fabric care actives or to separate certain fabric care actives from certain fabric cleaning agents in a multi-compartment container. It is further desirable to formulate compositions with different pHs in different compartments, allowing formulating different fabric care actives or formulating fabric caring actives with cleaning agents, at the pH that best suits their stability requirement.

In another mode or context, it is found to be technically desirable to cause the consumer to mix two compositions and to wait for a signal that mixing has been effective before using the combined composition in a washing machine. Such a signal, as has been discovered in the context of the present articles, and can be derivable from chemical reaction or a physical-chemical system change, e.g., a phase change, occurring on mixing.

In yet another mode or context, there is found to be a significant problem of consumer education in connection with one-part compositions. When all the components of a fabric care system or of a combined cleaning and/or fabric care system are integrated into a single container, it is difficult to persuade the consumer to change habits, for example with respect to dosing of the cleaning and care system, or even to have the consumer understand how the integrated composition in its single container can produce new or different cleaning and/or care results. Thus in certain embodiments of the present invention there is an underlying theme of separating ingredients, e.g., certain fabric care actives from each other or certain fabric cleaning agents from certain fabric care actives, even when there is no fundamental incompatibility thereof, but instead, for the purpose of giving the consumer a new and useful indication of what is being accomplished by means of an act of combining or mixing in which they themselves play a role. It is surprising and unexpected to discover that separating non-reactive ingredients that have different functions, e.g., for cleaning and/or for fabric care, can provide significant improvements in consumer acceptance and understanding, irrespective of the additional presence or absence of a signaling event that occurs on mixing.

In yet another mode or context, desirable technical phenomena other than promotion of stability are enabled by first keeping separate, and then mixing cleaning/care multi-component compositions shortly or immediately before use. Such phenomena are believed to include dynamic mixing effects and/or transient or dynamic interactions of the components. Dynamic phenomena, as compared to equilibrium phenomena, have been under-exploited in the field of laundry detergency.

In yet another mode or context, it has been discovered that a dissymmetry can be introduced between (a) the technically operational compatibilities or incompatibilities of fabric care actives and/or fabric cleaning agents and (b) a signaling system. In this mode, a group of ingredients (e.g., comprising fabric cleaning agents) which are not necessarily optimally stable or compatible together are copackaged in a first compartment and another group of ingredients (e.g., comprising fabric care actives) also not necessarily optimally stable or compatible together are copackaged together in a second compartment. In this mode, it is not optimal compatibility of materials in each compartment which is sought, but rather, good efficacy of the signaling (e.g., via odor, color, phase, temperature changes, etc.) which occurs when the compositions are mixed.

### SUMMARY OF THE INVENTION

In a first aspect, the present invention encompasses a laundry article for use in providing fabric care benefits to fabrics, the article comprising:

a) a container having at least two compartments (Typically two); and

b) a fabric care composition in at least one compartment, said fabric care composition having at least one fabric care active selected from the group consisting of fabric softeners, textile color care agents, textile property modifiers, textile odor modifiers, and mixtures thereof.

This laundry article can further provide cleaning when such fabric care composition further comprises a fabric cleaning agent.

In a second aspect, the present invention encompasses a laundry article for use in providing cleaning in addition to fabric care benefits to fabrics, the article comprising:

a) a container having at least two compartments (Typically two);

b) a fabric care composition in a first compartment, said fabric care composition having at least one fabric care active selected from the group consisting of fabric softeners, textile color care agents, textile property modifiers, textile odor modifiers, and mixtures thereof; and

c) a fabric cleaning composition in a second compartment, said fabric cleaning composition having at least one fabric cleaning agent.

In a third aspect, the present invention encompasses a laundry article for use in providing cleaning and fabric care benefits to fabrics, the article comprising:

a) a container having multiple compartments (typically two);

b) a fabric cleaning composition having at least one essential fabric cleaning agent (by definition herein below, this component is a fabric cleaning agent other than a surfactant or a bleach) in a first compartment; and

c) a fabric care composition in at least one additional compartment, said fabric care composition having at least one fabric care active.

In a preferred article, each of said components (b) and (c) is in the form of a liquid. Preferably, any of said liquids has a viscosity in the range 1 to 3000, and preferably 10 to 1000 cps at 20 s−1 and 20° C. Where the liquid fabric cleaning and/or care compositions are to be used in substantially equal proportions, it is even more preferred that the liquids have substantially the same rheological properties. The viscosity values referenced herein are determined using a plate-plate controlled stress viscosimeter, specifically a Carimed CSL² 100.

The present invention in its different modes or embodiments solves one or more of the technical problems and/or meets and fulfills one or more of the unmet needs identified above, and others, by providing certain selected articles and methods. The aspects, objects, features and advantages of the invention will be clear from the following disclosure. All percentages, ratios and proportions herein are on a weight basis unless otherwise indicated. All documents cited herein are hereby incorporated by reference. While particular embodiments of the subject invention are described, changes and modifications of the invention can be made without departing from its spirit and scope: any and all such modifications are within the scope of the invention.

### DETAILED DESCRIPTION

Laundry Articles

As noted in summary, the present invention relates to a laundry article which comprises (a) a container having multi-compartments, (b) a fabric care composition comprising a particularly defined fabric care active and optionally (c) a fabric cleaning composition.

Container Having Multi-Compartments

Containers having multiple compartments that are suitable for use herein in general include those having two, three or more, typically two compartments. The containers are especially those suitable for dispensing a plurality of doses of two-part or multi-part liquid laundry detergents. Such containers differ for example from toothpaste tubes, glue dispensers and other multi-part containers. For example, a small two-compartment toothpaste tube or cosmetics package is unsuitable for use as the container herein. The containers herein also differ from those integral to washing machines, i.e., they are not washing machine integral dispensers and do not generally involve expensive parts such as pistons, pumps, or the like. When the containers of the present invention have walls made from a single plastic, the preferred containers have relatively rigid walls, commonly made from polyethylene or similar plastics suitable for liquid detergent bottles, and the container is free-standing. Flexible walls may be contemplated, for example as in the case of flexible-walled wine containers, however then a relatively rigid outer structure, such as a carton structure, may be required to provide support.

Highly desirable containers have volumes permitting storage of from at least about 5 doses to about 50 doses of detergent, e.g., from about 10 to about 30 doses. Typical dosage volumes are from about 10 ml to about 200 ml for the total of volumes coming from the sum of all compartments. The relative dimensions of the compartments may vary, for example in a dual-compartment execution two equal dimensioned compartments may be used, but also embodiments are contemplated in which the compartments have different dimensions.

Especially useful containers are described in Copending U.S. patent applications filed Sep. 15, 2000 under U.S. Ser. No. 60/233,838; filed Oct. 30, 2000 under U.S. Ser. No. 60/244,307; and filed Mar. 23, 2001 under U.S. Ser. No. 60/278,124 and in copending commonly assigned European Patent Application, serial number 00870095.7 entitled “Multi Compartment Container”, filed May 5, 2000. Similarly, other containers such as those disclosed in U.S. Design Pat. No. D393,202, issued Apr. 7, 1998 to Chesebrough-Pond's USA Co., Division of Conopco, Inc. may also be used to advantage.

Containers having multiple compartments useful for use herein can be of types having a screw, pull, or snap cap at the top, which can be easily opened by the consumer to permit top-pouring from the multiple compartments. Alternately, containers having multi-compartments useful for use herein can be of types having a press tap located near the bottom, rather similar to a low-cost wine dispenser. Alternately, again the multi-compartments may be concentrically disposed.

A preferred container is free-standing and has openings for dispensing of the compositions. The openings can be positioned in the upper half of said container, for example for a top-pouring execution, or in the lower half of said container, for example to allow bottom-dispensing of the compositions. Preferred articles include also any suitable cap, such as a screw-on, snap or pull cap, of either a vented or a non-vented design.

In another preferred embodiments, the invention encompasses the article wherein the container has means for mixing a portion of the fabric care compositions or of the fabric cleaning and fabric care compositions before dispensing the mixed compositions into a laundry solution or laundry bath. Likewise, it is preferred that the article of the present invention have dispensing means associated with each compartment for regulating the flow of the composition from the compartment. Further still, is desirable that the dispensing means for different compartments regulate the flow of the compositions at different rates to enable proportional dispensing where the fabric care compositions or the fabric cleaning and fabric care compositions have different rheological properties.

Fabric Care Compositions/Essential Fabric Care Actives

The laundry article of the present invention comprises a fabric care composition in at least on compartment, wherein said fabric care composition comprises at least a fabric care active selected from the group consisting of (I) fabric softeners, (II) textile color care agents, (note that optical brighteners are not included in this component as they are treated as fabric cleaning agents for the purposes of the present invention), (III) textile property modifiers, from which textile odor modifiers are specifically excluded, (IV) textile odor modifiers, (V) fabric care actives other than (I)-(IV), and (VI) mixtures thereof. The fabric care active of the fabric care composition is preferably present at a level of from about 0.001% to about 80%, more preferably from about 0.1% to about 40% by weight of the fabric care composition. Preferred fabric care actives include the cationic fabric softener and cationic silicones. The fabric care composition may also comprise a number of other adjunct or optional ingredients that facilitate the fabric care function and/or improve its appeal to consumers.

Fabric Softeners (I)

Preferably the fabric care composition comprises at least one of said fabric softeners, and wherein said fabric softeners are selected from the group consisting of: (A) organic fabric softeners, (B) inorganic fabric softeners, e.g., clays, preferably hectorite clays, and (C) mixtures thereof and/or hybrid organic-inorganic fabric softeners. When present in one or more compositions of the articles of the present invention, fabric softeners are used in an amount between about 1% and about 30% by weight of the compositions.

One preferred group of fabric softeners for use as the fabric care active are organic fabric softeners (A), and wherein said organic fabric softener is selected from the group consisting of: (i) quaternary nitrogen-containing organic fabric softeners free from ester and/or amide moieties such as are disclosed in WO 00/24851, Barnabas et al., filed Oct. 22, 1999, beginning on page 61; (ii) quaternary nitrogen-containing organic fabric softeners comprising ester and/or amide and/or olefinically unsaturated moieties, preferably quaternary nitrogen-containing organic fabric softeners comprising ester moieties, such as are described in WO 00/24851 beginning on page 62; (iii) quaternary-nitrogen-free organic fabric softeners, such as are described in WO 00/24851, beginning on page 74; and (iv) mixtures thereof. Notably, the type (ii) organic fabric softeners described above are generally preferred over the type (i) organic fabric softeners. Preferred inorganic fabric softeners (B) for use in the articles of the present invention are clays, preferably smectite clays, more preferably hectorite clays, and the inorganic fabric softeners disclosed in WO 97/04065, Cauwberghs et al., Filed Jul. 11, 1996, beginning on page 5 and in EP 328 182. Hybrid organic-inorganic fabric softeners, such as organo-modified clays, that may be used to advantage in the articles of the present invention include organosilicones softeners amongst other materials. Bentone SD3, commercially available from Elementis is an example of these organo-modified clays.

Textile Color Care Agents (II)

A preferred group of fabric care actives are textile color care agents selected from the group consisting of dye fixatives, dye transfer inhibitors, color maintenance agents, whiteness enhancers, anti-fading agents including bleach scavengers and/or antioxidants, color appearance restoration agents of non-chelant types (e.g., the enzyme Carezyme® being a 43 kD endoglucanase, derived from Humicola insolens, DSM 1800 exhibiting a cellulase activity and commercially available from Novozyme, DK.), brightness restoration agents e.g., antiencrustation agents, UV protection agents for fabrics, sun fade inhibitors, anti-fading agents, and mixtures thereof. Such materials are well known to those skilled in the art and descriptions thereof are common in the patent literature such as found in U.S. Pat. No. 6,107,270, issued to Smith et al. on Aug. 22, 2000, and No. 6,020,302 Leurentop et al. on Feb. 1, 2000, commonly assigned to The Procter and Gamble Company.

“Textile color care agents” as used herein refers to materials that provide a color care benefit to laundered fabrics primarily by preserving the existing fabric colors and preventing their degradation. “Textile color care agents” should not be understood to refer to optical brighteners or other cleaning agents as described below. Textile color care agents are not intended to provide a general detersive effect such as is typical of bleaches and surfactants. When present in one or more compositions of the articles of the present invention, textile color care agents are used in an amount between about 0.1% and about 10% by weight of the compositions.

Dye Transfer Inhibitors

The polymeric dye transfer inhibiting agents are normally incorporated into the compositions of the present invention in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash. Especially suitable polymeric dye transfer inhibiting agents are polyamine N-oxide polymers, copolymers of N-vinylpyrrolidone and N-vinylimidazole, polyvinylpyrrolidone polymers, polyvinyloxazolidones and polyvinylimidazoles or mixtures thereof. Such materials are well known and are in general commercially available. By way of example, suitable polyvinylpyrrolidones (PVP) are commercially vailable from ISP Corporation, New York, N.Y. and Montreal, Canada under the product names PVP K-15 (MW 10,000), PVP K-30 (average molecular weight of 40,000), PVP K-60 (average molecular weight of 160,000), and PVP K-90 (average molecular weight of 360,000). Other suitable polyvinylpyrrolidones that are commercially available from BASF Cooperation include Sokalan HP 165 and Sokalan HP 12. Further, PVPs are described in for example EP-A-262,897 and EP-A-256,696. Other suitable polymeric dye transfer inhibitors that may be used to advantage in the compositions of the present invention include N-vinylimidazole N-vinylpyrrolidone polymers (PVPVI) as disclosed in EP 635 565, EP 635 567 and in U.S. Pat. No. 5,804,543. In addition, some cross-linked polymers having a three-dimensional rigid structure, can entrap dyes in the pores formed by the structure, or by swelling. Such cross-linked polymers are described in U.S. Pat. No. 5,912,221.

Dye Fixative

Dye fixing agents, “fixatives”, or “fixing agents” are well-known, commercially available materials which are designed to improve the appearance of dyed fabrics by minimizing the loss of dye from fabrics due to washing. Not included within this definition are components which can in some embodiments serve as fabric softener actives. Many fixing agents for anionic dyes are cationic, and are based on quaternized nitrogen compounds or on nitrogen compounds having a strong cationic charge which is formed in situ under the conditions of usage. Fixing agents are available under various trade names from several suppliers. Representative examples include: CROSCOLOR PMF (July 1981, Code No. 7894) and CROSCOLOR NOFF (January 1988, Code No. 8544) ex Crosfield; INDOSOL E-50 (Feb. 27, 1984, Ref. No. 6008.35.84; polyethyleneimine-based) ex Sandoz; SANDOFIX TPS, ex Sandoz, is a preferred dye fixative for use herein. Additional non-limiting examples include SANDOFIX SWE (a cationic resinous compound) ex Sandoz, REWIN SRF, REWIN SRF-O and REWIN DWR ex CHT-Beitlich GMBH; Tinofix® ECO, Tinofix® FRD and Solfin® ex Ciba-Geigy and described in WO 99/14301. Other preferred fixing agents for use in the compositions of the present invention are CARTAFIX CB® ex Clariant and the cyclic amine based polymers, oligomers or copolymers described in WO 99/14300. Other fixing agents useful herein are described in “Aftertreatments for Improving the Fastness of Dyes on Textile Fibres”, Christopher C. Cook, Rev. Prog. Coloration, Vol. XII, (1982). Dye fixing agents suitable for use in the present invention are ammonium compounds such as fatty acid-diamine condensates, inter alia the hydrochloride, acetate, methosulphate and benzyl hydrochloride salts of diamine esters. Non-limiting examples include oleyldiethyl aminoethylamide, oleylmethyl diethylenediamine methosulphate, and monostearylethylene diaminotrimethylammonium methosulphate. In addition, N-oxides other than surfactant-active N-oxides, more particularly polymeric N-oxides such as polyvinylpyridine N-oxide, are useful as fixing agents herein. Other useful fixing agents include derivatives of polymeric alkyldiamines, polyamine-cyanuric chloride condensates, and aminated glycerol dichlorohydrins.

Textile Property Modifiers (III)

Another preferred group of fabric care actives are textile property modifiers (III) selected from the group consisting of fabric bodying agents, fabric drape and form control agents, fabric smoothness agents, static control agents other than fabric softeners inherently possessing static control ability, fabric wrinkle control and/or ironing aid agents, finishing agents, fabric integrity agents, fabric anti-abrasion agents, fabric anti-wear agents, humectants and/or lubricants, pill removal agents, insect repellents, mite control agents, non-bleaching fabric sanitizers, e.g., fabric substantive antibacterials and/or antiviral agents and/or antifungals, flame retardants and mixtures thereof. “Textile property modifiers” specifically excludes odor modifiers which are treated separately herein.

Silicone Polymers

Silicone polymers, especially polydimethylsiloxanes and their functionalized derivatives are well known as textile property modifiers for providing a number for fabric care benefits. They can be implemented into laundry detergents for use in the main wash, in fabric softener compositions for use in the rinse and in post-laundering applications. Their use in heavy duty liquids is disclosed in WO 97/31997, Zhen et al. filed Feb. 14, 1997, and WO 97/31998, Zhen et al. filed Feb. 14, 1997, both of which are commonly assigned to The Procter & Gamble Company. Suitable silicone polymers for use herein can in general be charged or non-charged, linear or cyclic, have a wide range of molecular weights, water soluble, water insoluble or water dispersible. Uncharged polydimethylsiloxanes are for instance disclosed for use in fabric softening compositions in WO 00/71806 A1, Clarke et al. filed May 8, 2000, and WO 00/71807 A1, Clarke et al. filed May 8, 2000, that are commonly assigned to Lever. Further, silicone polymers suitable herein can be reactive or non reactive with fabrics or with ingredients of detergents or fabric enhancers. They can be curable or not curable in the traditional sense of the silicone art. Curable polymers are typically functionalized silicone polymers, usually polydimethylsiloxane polymers wherein additional organic functional groups have been introduced into the chemical structure of the polymer. Examples of silicone polymers comprising such functional groups are the polyalkyleneoxide modified polysiloxanes and the amino modified polylsiloxanes. Another class of silicone polymers is the linear aminopolydimethylsiloxane polyalkyleneoxide copolymers, such as the ones disclosed in WO 97/32917, Czech, filed Mar. 4, 1997 and assigned to Witco. Preferred silicone polymers are the cationic siloxane polymers, such as the polydimethylsiloxane polymers comprising at least one quaternized nitrogen atom. When the silicone polymer is cationic, any suitable anionic counterion can be used. A particularly preferred class of cationic silicone polymers is the multicationic silicone polymers described in WO 99/32539 (P&G). Particularly preferred are cationic silicone polymers comprising one or more polysiloxane, preferably polydimethylsiloxane units, preferably two or more such units and one or more, preferably two or more quaternary nitrogen moieties, the latter two or more quaternary nitrogen moieties preferably covalently connected to form an organosilicon-free moiety or moieties wherein each organosilicon-free moiety comprises two or more quaternary nitrogen atoms. Such cationic silicone polymers include polymers comprising one or more polysiloxane units, preferably polydimethylsiloxane units of formula —{(CH₃)₂SiO}ₙ— having a degree of polymerization, n, of from 50 to 200 and organosilicon-free units comprising at least one diquaternary unit. Most preferably, the selected cationic silicone polymer has from 0.50 to 1.0 weight fraction of said organosilicon-free units selected from N,N,N′,N′-tetramethyl-1,6-hexanediammonium units. The selected cationic silicone polymer can also contain from 0.0 to 0.20 weight fraction, in certain embodiments a non-zero amount, of the total of organosilicon-free units of —NHCH(CH₃)CH₂O(AO)ₐCH₂CH(CH₃)NH— units wherein AO represents ethyleneoxy, propyleneoxy, butyleneoxy and mixtures thereof and a is from 5 to 70.

The selected cationic silicone polymer can also contain from 0.0 to 0.20 weight fraction, of the total of organosilicon-free units of —NR₃+ wherein R is alkyl, hydroxyalkyl or phenyl. These units can be thought of as end-caps. Moreover the selected cationic silicone polymer generally contains anions, selected from inorganic and organic anions, more preferably selected from saturated and unsaturated C₁-C₂₀ carboxylates and mixtures thereof, to balance the charge of the quaternary moieties, thus the cationic silicone polymer also comprises such anions in a quaternary charge-balancing proportion.

Also of interest in the present selection of preferred cationic silicone polymers is that the quaternary nitrogen is preferentially located in the “backbone” of the “linear” polymer, in contradistinction from alternate and less preferred structures in which the quaternary nitrogen is incorporated into a moiety or moieties that form a “pendant” or “dangling” structure off the “backbone”.

The structures are completed by terminal moieties that can be noncharged or, when charged, can comprise only one quaternary nitrogen atom, as in the moiety —NR₃+ wherein R is alkyl. Moreover a certain proportion of nonquaternary silicone-free moieties can be present, for example the moiety—NHCH(CH₃)CH₂O(AO)ₐCH₂CH(CH₃)NH-described hereinabove.

Another particularly preferred class of cationic silicone polymers are those comprising one or more polysiloxane units, preferably polydimethylsiloxane units of formula —{(CH₃)₂SiO}ₙ— having a degree of polymerization, n, of from 50 to 200 and organosilicon-free units comprising at least one diquaternary unit as described on pages 10-17 of co-pending patent application U.S. Ser. No. 60/268174, filed on Feb. 12, 2001 by The Procter & Gamble Company. Preferred cationic silicone is those of Structure 2b on pages 13, line 22 to page 15 line 18 in such patent application U.S. Ser. No. 60/268174 as filed. More preferred is the cationic silicone described in example 1 having Structure 2, R¹=methyl, R²=(CH₂)₃, X=CH₂CHOHCH₂, cationic divalent moiety ii(a) with R⁴, R⁵, R⁶, R⁷ all methyl and Z¹ is (CH₂)₆. A=50% acetate, 50% laurate, weight basis; polyalkyleneoxide moiety (iii) of Structure 2 is NHCH(CH₃)CH₂O(C₂H₄O)₃₈(C₃H₆O)₆CH₂CH(CH₃)NH; cationic monovalent moiety iv(a) of Structure 2 has R¹², R¹³ and R¹⁴ all methyl; a=0; b=1; c=150; d=0; m=2.

When not otherwise known or available in commerce, the cationic silicone polymers can be prepared by conventional techniques.

When present in one or more compositions of the articles of the present invention, textile property modifiers are used in an amount between about 0.1% and about 10% by weight of the compositions.

Anti-Abrasion—Fabric Integrity Agents

Suitable textile color care agents include polyamide-polyamine materials that comprise epichlorohydrin adducts of polyamide-polyamines which are the reaction products of diethylenetriamine and adipic acid. The benefits of using these materials include improvements in the overall appearance, pill/fuzz reduction, and antifading of fabric treated with these materials. Such materials are commercially marketed by Hercules, Inc. under the tradename Kymene® such as Kymene 557H® and Kymene 557LX®. Other suitable materials include the Reten® and Delsette® that are also marketed by Hercules, as well as materials marketed by Sandoz under the tradename Cartaretin ®.

Anti-abrasion polymers may also be used to advantage in the compositions of the present invention are water-soluble polymers having the formula:

[—P(D)ₘ—]ₙ

wherein the unit P is a polymer backbone which comprises units which are homopolymeric or copolymeric. D units are defined herein below. The term “homopolymeric” is defined as “a polymer backbone which is comprised of units having the same unit composition, i.e., formed from polymerization of the same monomer. The term “copolymeric” is defined as “a polymer backbone which is comprised of units having a different unit composition, i.e., formed from the polymerization of two or more monomers”.

P backbones preferably comprise units having the formula:

—[CR₂—CR₂]— or —[(CR₂)ₓ—L]—

wherein each R unit is independently hydrogen, C₁-C₁₂ alkyl, C₆-C₁₂ aryl, and D units as described herein below; preferably C₁-C₄ alkyl.

Each L unit is independently selected from heteroatom-containing moieties, non-limiting examples of which are selected from the group consisting of:

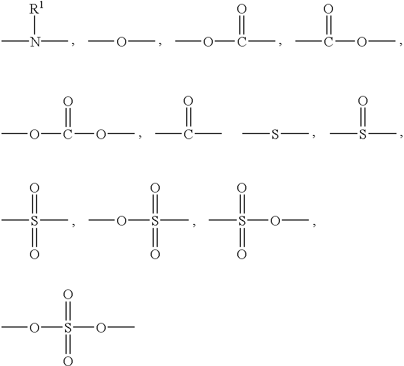

polysiloxane having the formula:

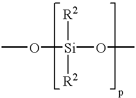

units which have dye transfer inhibition activity:

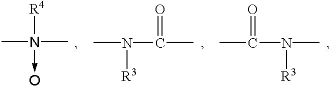

and mixtures thereof; wherein R¹ is hydrogen, C₁-C₁₂ alkyl, C₆-C₁₂ aryl, and mixtures thereof. R² is C₁-C₁₂ alkyl, C₁-C₁₂ alkoxy, C₆-C₁₂ aryloxy, and mixtures thereof; preferably methyl and methoxy. R³ is hydrogen C₁-C₁₂ alkyl, C₆-C₁₂ aryl, and mixtures thereof; preferably hydrogen or C₁-C₄ alkyl, more preferably hydrogen. R⁴ is C₁-C₁₂ alkyl, C₆-C₁₂ aryl, and mixtures thereof.

The backbones of the fabric abrasion reducing polymers comprise one or more D units that are units which comprise one or more units which provide a dye transfer inhibiting benefit. The D unit can be part of the backbone itself as represented in the general formula:

[—P(D)ₘ—]ₙ

or the D unit may be incorporated into the backbone as a pendant group to a backbone unit having, for example, the formula:

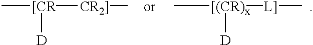

However, the number of D units depends upon the formulation. For example, the number of D units will be adjusted to provide water solubility of the polymer as well as efficacy of dye transfer inhibition while providing a polymer that has fabric abrasion reducing properties. The molecular weight of the fabric abrasion reducing polymers of the present invention are from about 500, preferably from about 1,000, more preferably from about 100,000 most preferably from 160,000 to about 6,000,000, preferably to about 2,000,000, more preferably to about 1,000,000, yet more preferably to about 500,000, most preferably to about 360,000 daltons. Therefore the value of the index n is selected to provide the indicated molecular weight, and providing for a water solubility of least 100 ppm, preferably at least about 300 ppm, and more preferably at least about 1,000 ppm in water at ambient temperature which is defined herein as 25° C.

Non-limiting examples of preferred D units are units that comprise an amide moiety. Examples of polymers wherein an amide unit is introduced into the polymer via a pendant group includes polyvinylpyrrolidones, polyvinyloxazolidones, polyvinylmethyloxazolidones, polyacrylamides and N-substituted polyacrylamides, polymethacrylamides and N-substituted polymethacrylamides, poly N-acrylylglycinamides, poly N-methacrylylglycinamide, and polyvinylurethanes. An example of a D unit wherein the nitrogen of the dye transfer inhibiting moiety is incorporated into the polymer backbone is a poly(2-ethyl-2-oxazoline) having the formula:

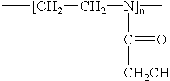

wherein the index n indicates the number of monomer residues present. The fabric abrasion reducing polymers useful in the present invention can comprise any mixture of dye transfer inhibition units that provides the product with suitable properties. The preferred polymers that comprise D units which are amide moieties are those which have the nitrogen atoms of the amide unit highly substituted so the nitrogen atoms are in effect shielded to a varying degree by the surrounding non-polar groups. This provides the polymers with an amphiphilic character. Non-limiting examples include polyvinyl-pyrrolidones, polyvinyloxazolidones, N,N-disubstituted polyacrylamides, and N,N-disubstituted polymethacrylamides. A detailed description of physical-chemical properties of some of these polymers are given in “Water-Soluble Synthetic Polymers: Properties and Behavior”, Philip Molyneux, Vol. I, CRC Press, (1983) included herein by reference.

Another D unit which provides dye transfer inhibition enhancement to the fabric abrasion reducing polymers described herein, are N-oxide units. The N-oxide unit may be part of a polymer, such as a polyamine, i.e., polyalkyleneamine backbone, or the N-oxide may be part of a pendant group attached to the polymer backbone. An example of a polymer which comprises an the N-oxide unit as a part of the polymer backbone is polyethyleneimine N-oxide. Non-limiting examples of groups which can comprise an N-oxide moiety include the N-oxides of certain heterocycles inter alia pyridine, pyrrole, imidazole, pyrazole, pyrazine, pyrimidine, pyridazine, piperidine, pyrrolidine, pyrrolidone, azolidine, morpholine. A preferred polymer is poly(4-vinylpyridine N-oxide, PVNO). In addition, the N-oxide unit may be pendant to the ring, for example, aniline oxide.

A further example of polymers which are fabric abrasion reducing polymers which have dye transfer inhibition benefits are polymers which comprise both amide units and N-oxide units as described herein above. Non-limiting examples include co-polymers of two monomers wherein the first monomer comprises an amide unit and the second monomer comprises an N-oxide unit. In addition, oligomers or block polymers comprising these units can be taken together to form the mixed amide/N-oxide polymers. However, the resulting polymers must retain the water solubility requirements described herein above.

Additional description of the anti-abrasion polymers useful in the compositions of the present invention are disclosed in WO 98/29530, Randall et al. filed Dec. 9, 1997. Also preferred are the cationically modified polyacrylamide as described on pages 12-13 of WO 00/56848 to the Procter & Gamble Company.

Textile Odor Modifiers (IV)

Other preferred fabric care actives are textile odor modifiers comprise perfumes, (preferably pro-perfumes and/or substantive perfumes and/or perfumes combined with perfume carriers), odor enhancers, malodor control agents and mixtures thereof. When present in one or more compositions of the articles of the present invention, textile odor modifiers are used in an amount between about 0.1% and about 10% by weight of the compositions.

Perfumes

Pro-perfumes are useful in the fabric care compositions to mask malodor on fabric. A pro-perfume is defined as a perfume precursor that releases a desirable odor and/or perfume molecule through the breaking of a chemical bond. Typically to form a pro-perfume, a desired perfume raw material is chemically linked with a carrier, preferably a slightly volatile or a sparingly volatile carrier. The combination results in a less volatile and more hydrophobic pro-perfume that has improved deposition onto fabrics. The perfume is then released by breaking the bond between the perfume raw material and the carrier either through a change in pH (e.g., due to perspiration during wear), air moisture, heat, and/or sunlight during storage or line drying. Thus, malodor is effectively masked by the release of the perfume raw material.

The perfume raw material used in pro-perfumes are typically saturated or unsaturated, volatile compounds that contain an alcohol, an aldehyde, and/or a ketone group. The perfume raw materials useful herein include fragrant substances or mixtures of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. The perfume raw material(s) is often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

A preferred pro-perfume useful herein is described in columns 7-14 of U.S. Pat. No. 5,378,468 to Suffis, et al., issued on Jan. 3, 1995; and in U.S. Pat. No. 5,652,205 to Hartman, et al., issued on Jul. 29, 1997.

Malodor Control Agents

The malodor control agents useful herein comprise cyclodextrins, ammonium antimicrobial agents and mixtures thereof. Unless otherwise noted below, the composition of the present invention comprises from about 0.05% to about 15% by weight of a malodor control agent.

The term “cyclodextrin” includes any of the known cyclodextrins such as unsubstituted cyclodextrins containing from six to twelve glucose units, especially, alpha-cyclodextrin, beta-cyclodextrin, gamma-cyclodextrin, their derivatives and mixtures thereof as described in details on pages 9-12 of WO96/04940. Cyclodextrins that are especially useful in the compositions of the present invention are highly water-soluble such as, alpha-cyclodextrin and derivatives thereof, gamma-cyclodextrin and derivatives thereof, derivatised beta-cyclodextrins, and mixtures thereof. It is also preferable to use a mixture of cyclodextrins. Such mixtures absorb odors more broadly by complexing with a wider range of odoriferous molecules having a wider range of molecular sizes. Further, it is also preferable to use a less soluble cyclodextrin or mixture containing such a cyclodextrin to promote deposition of the cyclodextrin on the clothing in the rinse solution.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The presence of solubilized, uncomplexed cyclodextrins is essential for effective and efficient odor control performance. Solubilized, water-soluble cyclodextrin can exhibit more efficient odor control performance than non-water-soluble cyclodextrin when deposited onto fabric. Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. Preferred cyclodextrins are commercially available, e.g., from Cerestar USA, Inc. and Wacker Chemicals (USA), Inc.

The derivatives of cyclodextrin consist mainly of molecules wherein some of the OH groups are converted to OR groups. Detail concerning cyclodextrin derivatives may be found in “Optimal Performances with Minimal Chemical Modification of Cyclodextrins”, F. Diedaini-Pilard and B. Perly, The 7th International Cyclodextrin Symposium Abstracts, April 1994, p. 49, said reference being incorporated herein by reference. Other cyclodextrin derivatives are disclosed in U.S. Pat. Nos.: 3,426,011; 3,453,257; 3,453,258; 3,453,259; 3,453,260; 3,459,731; 3,553,191; 3,565,887; 4,535,152; 4,616,008; 4,678,598; 4,638,058; and 4,746,734.

Malodor control agents may also include quaternary ammonium antimicrobial agents. The quaternary ammonium antimicrobial agents useful herein typically kill microorganisms located on the surface or in the fibers of fabric articles or otherwise prevent microorganism growth. Microorganisms such as bacteria and fungi may be a significant cause of malodor. While many types of antimicrobial agents are available, the antimicrobial agent useful herein should meet following requirements: i) it should be safe, and typically should not cause any adverse reactions on human skin; ii) effective at even low dosages, in case there is only a limited amount of deposition; and iii) sustainable for a long time to provide a residual antimicrobial efficacy even with the interaction of fabrics which are normally negatively charged.

It has been frequently observed that many strong antimicrobial agents lose or possess diminished antimicrobial efficacy upon interaction with negatively-charged surfaces. Normally, positively charged antimicrobial agents with high hydrophobicity will have a higher deposition efficiency. Positively charged quaternary amines (either alkyl or ring-containing) with long hydrophobic side chains are especially useful as antimicrobial agents in the compositions of the present invention. The general structure of this preferred quaternary ammonium antimicrobial agent is:

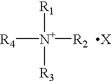

wherein R₁-R₄ are independently selected from C₁-C₂₂ alkyl groups, where X is a negatively charged group, which is preferably selected from the group consisting of halogen, acetic acid or other small negative ions. One of the R₁-R₄ group has a chain length longer than C₁₀. Preferably, R₁ and R₂ are both methyl, while R₃ and R₄ are long chain alkyl groups (e.g., C₁₀-C₁₈). More preferably, R₁ and R₂ are both methyl, and R₃ and R₄ are C₁₀ alkyl chains; this antimicrobial agent is known as didecyl dimethyl ammonium. Didecyl dimethyl ammonium chloride is available from Lonza Inc., Fair Law, N.J., USA, as BARDAC™. The formula for BARDAC™ is:

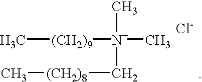

Another highly preferred quaternary ammonium antimicrobial agent useful herein is a benzalkonium (R₁ and R₂ are both methyl, R₃ is methylbenzyl and R₄ is —(CH₂)ₙ—CH₃, wherein n is 12-18), or a mixture thereof, such as benzalkonium chloride having the formula below. Preferably, n is from 12 to 18.

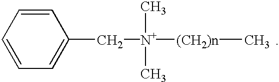

Fabric Cleaning Compositions/Essential Fabric Cleaning Agents

Optionally, the laundry article of the present invention can further comprise a fabric cleaning composition having at least one fabric cleaning agent. Said fabric cleaning agent can be any suitable agent commonly used in laundry cleaning applications such as surfactant, builder, detersive enzymes, bleach systems, optical brighteners, fluorescent whitening agents, chelants or sequestrants, builders, alkalinity, soil suspending agents, soil release agents, stain resistance agents, and the like. Suitable surfactant and bleach ingredients are described hereinafter. Preferably, the fabric cleaning agents are maintained in separate compartments prior to dispensing to achieve better stability.

In another embodiment, the fabric cleaning composition of the present invention does not comprise a surfactant or bleach as the only fabric cleaning agent. In this instance, the essential fabric cleaning agent used in the fabric cleaning composition component of the invention is defined as a cleaning agent suitable for fabrics provided that this essential cleaning agent is not a surfactant or bleach. While the essential cleaning agent will not be selected from surfactant or bleach, it is anticipated that there may be surfactant(s) and/or bleach in the fabric cleaning composition, in addition to one or more of the essential fabric cleaning agents as described herein.

Suitable examples of “fabric cleaning agent” as defined herein include detersive cleaning enzymes, especially amylases, proteases and other hydrolases such as lipases, although any enzyme having cleaning effect can be used. Other “fabric cleaning agents” as defined herein include optical brighteners, fluorescent whitening agents, chelants or sequestrants, builders (especially for control of calcium and/or magnesium), alkalinity, soil suspending agents, soil release agents, stain resistance agents, and the like. Such cleaning agents are described in detail in the patent literature concerning detergent compositions, such as found in U.S. Pat. Nos. 6,103,685 issued to Hall et al., Aug. 15, 200 and 6,113,655 issued to Tsunetsugu et al., Sept. 5, 2000, that are commonly assigned to The Procter and Gamble Company. Preferred essential cleaning agents are the protease and amylase enzymes, phosphonate chelants and citric acid builders.

Suitable total levels of the essential cleaning agent or mixtures of such essential cleaning agents, as a percentage by weight of the fabric cleaning composition component of the invention, are from about 0.0001% to about 80%. These ingredients are preferably used at their usual heavy-duty liquid detergent levels, see for example the ingredients and levels disclosed in “Surfactant Science Series”, Marcel Dekker, New York, various volumes pertaining to heavy duty liquid detergents.

Enzymes

Enzymes suitable for use as the essential fabric cleaning agent include enzymes that provide the removal of protein-based, carbohydrate-based, or triglyceride-based stains from textiles, the prevention of refugee dye transfer during laundering, and fabric restoration amongst other fabric cleaning benefits. Suitable enzymes include cellulases, proteases, amylases, lipases, cellulases, peroxidases, and mixtures thereof of any suitable origin, such as vegetable, animal, bacterial, fungal and yeast origin. Preferred selections are influenced by factors such as pH-activity and/or stability optima, thermostability, and the like. In this respect, bacterial or fungal enzymes are preferred, such as bacterial amylases and proteases, and fungal cellulases.

Suitable proteases are the subtilisins that are obtained from particular strains of B. subtilis, B. licheniformis and B. amyloliquefaciens (subtilisin BPN and BPN′), B. alcalophilus and B. lentus. Suitable Bacillus protease is Esperease® with maximum activity at pH 8-12, sold by Novozymes and described with its analogues in GB 1,243,784. Other suitable proteases include Alcalase®, Everlase® and Savinase® from Novozymes. Proteolytic enzymes also encompass modified bacterial serine proteases, such as those described in EP 251 446 (particularly pages 17, 24 and 98), referred to as “Protease B”, and in EP 199 404 which refers to a modified enzyme referred to as “Protease A”. Also suitable is the enzyme called “Protease C”, which is a variant of an alkaline serine protease from Bacillus (WO 91/06637). A preferred protease referred to as “Protease D” is a carbonyl hydrolase variant having an amino acid sequence not found in nature, described in WO95/10591 and WO95/10592. Preferred proteases are multiply-substituted protease variants comprising a substitution of an amino acid residue at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin. WO 99/20723, WO99/20726, WO99/20727, WO99/20769, WO99/20770 and WO99/20771 describe also suitable proteases, wherein preferred variants have the amino acid substitution set 101/103/104/159/232/236/245/248/252, more preferably 101G/103A/104I/159D/232V/236H/245R/248D/252K according to the BPN′ numbering.

Amylases (α and/or β) can be included for removal of carbohydrate-based stains. Suitable amylases are described in WO94/02597 and WO95/10603 (both Novozymes). WO95/26397 describes other suitable amylases: a-amylases characterised by having a specific activity at least 25% higher than the specific activity of Termamyl® at a temperature range of 25° C. to 55° C. and at a pH value in the range of 8 to 10, measured by the Phadebas® a-amylase activity assay. Suitable variants of the above enzymes are described in WO96/23873 (Novozymes). Examples of commercial a-amylases products are Purafect Ox Am® from Genencor and Termamyl®, Ban®, Fungamyl® and Duramyl®, all available from Novozymes.

Suitable cellulases include both bacterial and fungal cellulases, preferably with a pH optimum of between 5 and 12. Examples are cellulases produced by a strain of Humicola insolens (Humicola grisea var. thermoidea), particularly the Humicola strain DSM 1800. Other suitable cellulases are cellulases originated from Humicola insolens having a molecular weight of about 50 KDa, an isoelectric point of 5.5 and containing 415 amino acids;; a preferred endoglucanase component has the amino acid sequence disclosed in WO 91/17243. Also suitable cellulases are the EGIII cellulases from Trichoderma longibrachiatum (WO94/21801, Genencor). Especially suitable cellulases are the cellulases having color care benefits such as described in EP 495 257. Celluzyme® commercially available from Novozymes is especially useful. Other suitable cellulases for fabric care and/or cleaning properties are described in WO96/34092, WO96/17994 WO95/24471, WO91/17244 and WO91/21801.

Suitable lipases include those produced by the Pseudomonas group, such as P. stutzeri ATCC 19.154 (GB1,372,034). Suitable lipases include those showing a positive immunological cross-reaction with the antibody of the Pseudomonas fluorescent llipase AM 1057 available from Amano Pharmaceutical Co. Ltd Japan, under the trade name “Lipase P Amano”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands; and lipases ex Pseudomonas gladioli. Especially suitable are the lipases produced by Pseudomonas pseudoalcaligenes (EP 218 272) or variants thereof (WO9425578) previously supplied by Gist-Brocades as M1 Lipase® and Lipomax® (Gist-Brocades). Preferred lipases are the Lipolase® and Lipolase Ultra® from Novozymes. Also suitable are the enzymes described in EP 258 068, EP 943678, WO 92/05249, WO 95/22615, WO 9942566, WO 200060063 (all by Novozymes) and in WO 94/03578, WO 95/35381 and WO 96/00292 by Unilever.

Also suitable are cutinases [EC 3.1.1.50] being considered as lipases which do not require interfacial activation. Suitable cutinases are described in WO88/09367 (Genencor); WO 90/09446 (Plant Genetic System); WO94/14963 and WO94/14964 (Unilever) and WO00/344560 (Novozymes).

Also suitable are bleaching enzymes, the following starch degrading enzymes: Cyclomaltodextrin glucanotransferase “CGTase” (E.C. 2.4.1.19), maltogenic alpha amylase (EC 3.2.1.133) and amyloglucosidase (EC 3.2.1.3); and the following carbohydrases: Mannanase (E.C. 3.2.1.78), protopectinase, polygalacturonase (E.C. 3.2.1.15), pectin lyase (E.C.4.2.2.10), pectin esterase (E.C. 3.1.1.11), pectate lyase (EC4.2.2.2) and Xyloglucanase.

Optical Brightners

Commercial optical brighteners that may be used as essential cleaning agents in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Specific examples of optical brighteners that are useful in the compositions of the present invention are those identified in U.S. Pat. No. 4,790,856, issued to Wixon on Dec. 13, 1988. These brighteners include the PHORWHITE series of brighteners from Verona. Other brighteners disclosed in this reference include: Tinopal UNPA, Tinopal CBS and Tinopal 5BM; available from Ciba-Geigy; Artic White CC and Artic White CWD, available from Hilton-Davis, located in Italy; the 2-(4-stryl-phenyl)-2H-napthol[1,2-d]triazoles; 4,4′-bis- (1,2,3-triazol-2-yl)-stilbenes; 4,4′-bis(stryl)bisphenyls; and the aminocoumarins. Specific examples of these brighteners include 4-methyl-7-diethyl- amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d]oxazole; and 2-(stilbene-4-yl)-2H-naphtho-[1,2-d]triazole. See also U.S. Pat. No. 3,646,015, issued Feb. 29, 1972 to Hamilton. Anionic brighteners are preferred herein.

More specifically, the hydrophilic optical brighteners useful in the present invention are those having the structural formula:

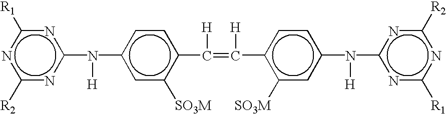

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium. Commercially available brightners having this structure are available from the Ciba-Geigy Corporation under the trade names Tinopal-UNPA-GX®, Tinopal-UNPA-GX, Tinopal 5BM-GX®, and Tinopal AMS-GX®.

Chelants

More specifically, chelants that will serve as an essential fabric cleaning agent can include one or more copper and/or nickel chelating agents (“chelators”), such as diethylenetriaminepentaacetic acid (DTPA) or ethylenediamine-N,N′-disuccinnic acid (EDDS). Water-soluble chelating agents can be selected from the group consisting of amino carboxylates, amino phosphonates, polyfunctionally-substituted aromatic chelating agents and mixtures thereof, all as hereinafter defined and all preferably in their acidic form. Amino carboxylates useful as chelating agents herein include ethylenediaminetetraacetic acid (EDTA), N-hydroxyethylethylenediaminetriacetates, nitrilotriacetates (NTA), ethylenediamine tetraproprionates, ethylenediamine-N,N′-diglutamates, 2-hyroxypropylenediamine-N,N′-disuccinates, triethylenetetraaminehexacetates, di-ethylenetriaminepenta acetates (DTPA) and ethanoldiglycines, including their water-soluble salts such as the alkali metal, ammonium, and substituted ammonium salts thereof and mixtures thereof. Amino phosphonates are also suitable and can include ethylenediaminetetrakis (methylenephosphonates), diethylenetriamine-N,N,N′,N″,N″-pentakis(methane phosphonate) (DTMP) and 1-hydroxyethane-1,1-diphosphonate (HEDP). Preferred chelating agents useful herein include those described in U.S. Pat. No. 5,686,376 to Rusche, et al., issued Nov. 11, 1997 included herein by reference in its entirety. Chelants can be present in the fabric cleaning composition in the range of from about 0.001% to about 10% by weight of the composition. More preferably the chelant is present in the range of from about 0.01% to about 5% and most preferably in the range of from about 0.01% to about 3% by weight of the composition. Chelants may also be used to advantage in the fabric care compositions of the present invention as well.

Soil Suspending and Soil Release Agents

The essential cleaning agent may also comprise one or more soil release, anti-redeposition and stain resistance agents.

Suitable soil release agents include polymers, and more preferably, copolymers having random blocks of ethylene terephthalate and polyethylene oxide (PEO) terephthalate. Descriptions of such copolymers and their uses are provided in U.S. Pat. No. 3,959,230 to Hays, issued May 25, 1976 and U.S. Pat. No. 3,893,929 to Basadur issued Jul. 8, 1975. Also suitable is a crystallizable polyester with repeating units of ethylene terephthalate containing from about 10% to about 15% by weight of ethylene terephthalate units together with from about 10% to about 50% by weight of polyoxyethylene terephthalate units that are derived from a polyoxyethylene glycol of average molecular weight of from about 300 to about 6,000. The molar ratio of ethylene terephthalate units to polyoxyethylene terephthalate units in such a crystallizable polymeric compound is between 2:1 and 6:1. Examples of this polymer include the commercially available materials Zelcon 4780® and Zelcon 5126 (from Dupont) and Milease T® (from ICI). See also U.S. Pat. No. 4,702,857, issued Oct. 27, 1987 to Gosselink.

Highly preferred soil release agents are polymers of the generic formula:

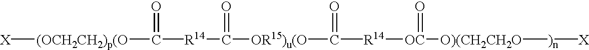

wherein X is typically selected from the group consisting of H, and alkyl or acyl groups containing from about 1 to about 4 carbon atoms; p is selected for water solubility and generally is from about 6 to about 113, preferably from about 20 to about 50; and u is critical to formulation in a liquid composition having a relatively high ionic strength. There should be very little material in which u is greater than 10. Furthermore, there should be at least 20%, preferably at least 40%, of material in which u ranges from about 3 to about 5. The R¹⁴ moieties are essentially 1,4-phenylene moieties consisting entirely of 1,4-phenylene moieties, or partially substituted with other arylene or alkarylene moieties, alkylene moieties, alkenylene moieties, or mixtures thereof. The R¹⁵ moieties are ethylene, substituted ethylene moieties and mixtures thereof. The value for each n usually ranges from about 12 to about 113.

Soil release agents characterized by poly(vinyl ester) hydrophobe segments include graft copolymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type materials, e.g., SOKALAN HP-22, available from BASF (Germany). Still another preferred soil release agent is an oligomer with repeating units of terephthaloyl, sulfoisoterephthaloyl, oxyethyleneoxy and oxy-1,2-propylene. The repeating units form the backbone of the oligomer and are preferably terminated with modified isethionate end-caps. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

Polymeric soil release agents useful in the present invention can also include cellulosic derivatives such as hydroxyether cellulosic polymers, and the like. Such agents are commercially available and include materials sold under the name METHOCEL (Dow). Cellulosic soil release agents for use herein also include those selected from the group consisting of C₁-C₄ alkyl and C₄ hydroxyalkyl cellulose described in U.S. Pat. No. 4,000,093, issued Dec. 28, 1976 to Nicol, et al.

The essential cleaning agents of the present invention may also comprise soil release and anti-redeposition agents such as water-soluble ethoxylated amines, most preferably ethoxylated tetraethylenepentamine. Exemplary ethoxylated amines are further described in U.S. Pat. No. 4,597,898, VanderMeer, issued Jul. 1, 1986. Preferred clay soil removal-antiredeposition agents are the cationic compounds disclosed in European Patent Application 111,965, Oh and Gosselink, published Jun. 27, 1984. Other clay soil removal/antiredeposition agents which can be used include the ethoxylated amine polymers disclosed in European Patent Application 111,984, Gosselink, published Jun. 27, 1984; the zwitterionic polymers disclosed in European Patent Application 112,592, Gosselink, published Jul. 4, 1984; and the amine oxides disclosed in U.S. Pat. No. 4,548,744, Connor, issued Oct. 22, 1985. Other anti-redeposition agents known in the art such as carboxymethylcellulose (CMC) materials can also be utilized in the compositions of the present invention.

A more complete disclosure of soil release agents is contained in U.S. Pat. Nos.: 4,018,569, Trinh, Gosselink and Rattinger, issued Apr. 4, 1989; 4,661,267, Decker, Konig, Straathof, and Gosselink, issued Apr. 28, 1987; 4,702,857, Gosselink, issued Oct. 27, 1987; 4,711,730, Gosselink and Diehl, issued Dec. 8, 1987; 4,749,596, Evans, Huntington, Stewart, Wolf, and Zimmerer, issued Jun. 7, 1988; 4,808,086, Evans, Huntington, Stewart, Wolf, and Zimmerer, issued Feb. 24, 1989; 4,818,569, Trinh, Gosselink, and Rattinger, issued Apr. 4, 1989; 4,877,896, Maldonado, Trinh, and Gosselink, issued Oct. 31, 1989; 4,956,447, Gosselink et al., issues Sep. 11, 1990; 4,968,451, Scheibel and Gosselink, issued Nov. 6, 1990; and 4,976,879, Maldonado, Trinh, and Gosselink, issued Dec. 11, 1990.

Surfactants

The fabric cleaning composition of the present invention may comprise at least about 0.01% by weight, preferably from about 0.1% to about 60%, preferably to about 30% by weight, of a detersive surfactant system, said system is comprised of one or more category of surfactants depending upon the embodiment, said categories of surfactants are selected from the group consisting of anionic, cationic, nonionic, zwitterionic, ampholytic surfactants, and mixtures thereof. Within each category of surfactant, more than one type of surfactant can be selected. Nonlimiting examples of surfactants useful herein include:

a) C₁₁-C₁₈ alkyl benzene sulfonates (LAS);

b) C₁₀-C₂₀ primary, branched-chain and random alkyl sulfates (AS);

c) C₁₀-C₁₈ secondary (2,3) alkyl sulfates having the formula:

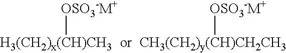

wherein x and (y+1) are integers of at least about 7, preferably at least about 9; said surfactants disclosed in U.S. Pat. No. 3,234,258 Morris, issued Feb. 8, 1966; U.S. Pat. No. 5,075,041 Lutz, issued Dec. 24, 1991; U.S. Pat. No. 5,349,101 Lutz et al., issued Sep. 20, 1994; and U.S. Pat. No. 5,389,277 Prieto, issued Feb. 14, 1995 each incorporated herein by reference;

d) C₁₀-C₁₈ alkyl alkoxy sulfates (AE_{X}S) wherein preferably x is from 1-7;

e) C₁₀-C₁₈ alkyl alkoxy carboxylates preferably comprising 1-5 ethoxy units;

f) C₁₂-C₁₈ alkyl ethoxylates, C₆-C₁₂ alkyl phenol alkoxylates wherein the alkoxylate units are a mixture of ethyleneoxy and propyleneoxy units, C₁₂-C₁₈ alcohol and C₆-C₁₂ alkyl phenol condensates with ethylene oxide/propylene oxide block polymers inter alia Pluronic® ex BASF which are disclosed in U.S. Pat. No. 3,929,678 Laughlin et al., issued Dec. 30, 1975, incorporated herein by reference;

g) Alkylpolysaccharides as disclosed in U.S. Pat. No. 4,565,647 Llenado, issued Jan. 26, 1986, incorporated herein by reference;

h) Polyhydroxy fatty acid amides having the formula:

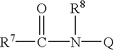

wherein R⁷ is C₅-C₃₁ alkyl; R⁸ is selected from the group consisting of hydrogen, C₁-C₄ alkyl, C₁-C₄ hydroxyalkyl, Q is a polyhydroxyalkyl moiety having a linear alkyl chain with at least 3 hydroxyls directly connected to the chain, or an alkoxylated derivative thereof; preferred alkoxy is ethoxy or propoxy, and mixtures thereof; preferred Q is derived from a reducing sugar in a reductive amination reaction, more preferably Q is a glycityl moiety; Q is more preferably selected from the group consisting of —CH₂(CHOH)ₙCH₂OH, —CH(CH₂OH)(CHOH)ₙ₋₁CH₂OH, —CH₂(CHOH)₂—(CHOR′)(CHOH)CH₂OH, and alkoxylated derivatives thereof, wherein n is an integer from 3 to 5, inclusive, and R′ is hydrogen or a cyclic or aliphatic monosaccharide, which are described in U.S. Pat. No. 5,489,393 Connor et al., issued Feb. 6, 1996; and U.S. Pat. No. 5,45,982 Murch et al., issued Oct. 3, 1995, both incorporated herein by reference.

The fabric cleaning compositions of the present invention can also comprise from about 0.001% to about 100% of one or more (preferably a mixture of two or more) mid-chain branched surfactants, preferably mid-chain branched alkyl alkoxy alcohols having the formula:

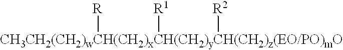

mid-chain branched alkyl sulfates having the formula:

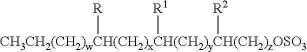

and mid-chain branched alkyl alkoxy sulfates having the formula:

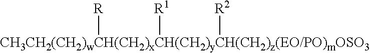

wherein the total number of carbon atoms in the branched primary alkyl moiety of these formulae (including the R, R¹, and R² branching, but not including the carbon atoms which comprise any EO/PO alkoxy moiety) is from 14 to 20, and wherein further for this surfactant mixture the average total number of carbon atoms in the branched primary alkyl moieties having the above formula is within the range of greater than 14.5 to about 17.5 (preferably from about 15 to about 17); R, R¹, and R² are each independently selected from hydrogen, C₁-C₃ alkyl, and mixtures thereof, preferably methyl; provided R, R¹, and R² are not all hydrogen and, when z is 1, at least R or R¹ is not hydrogen. M is a water soluble cation and may comprises more than one type of cation, for example, a mixture of sodium and potassium. The index w is an integer from 0 to 13; x is an integer from 0 to 13; y is an integer from 0 to 13; z is an integer of at least 1; provided w+x+y+z is from 8 to 14. EO and PO represent ethyleneoxy units and propyleneoxy units having the formula:

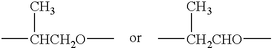

respectively, however, other alkoxy units inter alia 1,3-propyleneoxy, butoxy, and mixtures thereof are suitable as alkoxy units appended to the mid-chain branched alkyl moieties.

The mid-chain branched surfactants are preferably mixtures which comprise a surfactant system. Therefore, when the surfactant system comprises an alkoxylated surfactant, the index m indicates the average degree of alkoxylation within the mixture of surfactants. As such, the index m is at least about 0.01, preferably within the range of from about 0.1, more preferably from about 0.5, most preferably from about 1 to about 30, preferably to about 10, more preferably to about 5. When considering a mid-chain branched surfactant system which comprises only alkoxylated surfactants, the value of the index m represents a distribution of the average degree of alkoxylation corresponding to m, or it may be a single specific chain with alkoxylation (e.g., ethoxylation and/or propoxylation) of exactly the number of units corresponding to m.

The preferred mid-chain branched surfactants of the present invention which are suitable for use in the surfactant systems of the present invention have the formula:

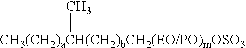

or the formula:

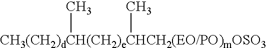

wherein a, b, d, and e are integers such that a+b is from 10 to 16 and d+e is from 8 to 14; M is selected from sodium, potassium, magnesium, ammonium and substituted ammonium, and mixtures thereof.

The surfactant systems of the present invention which comprise mid-chain branched surfactants are preferably formulated in two embodiments. A first preferred embodiment comprises mid-chain branched surfactants which are formed from a feedstock which comprises 25% or less of mid-chain branched alkyl units. Therefore, prior to admixture with any other conventional surfactants, the mid-chain branched surfactant component will comprise 25% or less of surfactant molecules which are non-linear surfactants.

A second preferred embodiment comprises mid-chain branched surfactants which are formed from a feedstock which comprises from about 25% to about 70% of mid-chain branched alkyl units. Therefore, prior to admixture with any other conventional surfactants, the mid-chain branched surfactant component will comprise from about 25% to about 70% surfactant molecules which are non-linear surfactants.

The surfactant systems of the fabric cleaning compositions of the present invention can also comprise from about 0.001%, preferably from about 1%, more preferably from about 5%, most preferably from about 10% to about 100%, preferably to about 60%, more preferably to about 30% by weight, of the surfactant system, of one or more (preferably a mixture of two or more) mid-chain branched alkyl arylsulfonate surfactants, preferably surfactants wherein the aryl unit is a benzene ring having the formula:

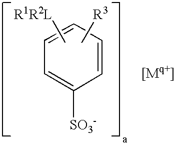

wherein L is an acyclic hydrocarbyl moiety comprising from 6 to 18 carbon atoms; R¹, R², and R³ are each independently hydrogen or C₁-C₃ alkyl, provided R¹ and R² are not attached at the terminus of the L unit; M is a water soluble cation having charge q wherein a and b are taken together to satisfy charge neutrality.

Furthermore, the present invention may comprise from about 0%, preferably from about 0.5% to about 10%, preferably to about 0.5%, more preferably to about 4%, most preferably to about 3% by weight, of one or more polyoxyalkylene alkyl amide surface active agent. The nonionic surfactants suitable for use in the present invention have the formula:

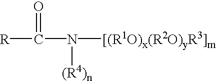

wherein R is C₇-C₂₁ linear alkyl, C₇-C₂₁ branched alkyl, C₇-C₂₁ linear alkenyl, C₇-C₂₁ branched alkenyl, and mixtures thereof; R¹ is ethylene; R² is C₃-C₄ linear alkyl, C₃-C₄ branched alkyl, and mixtures thereof; preferably R² is 1,2-propylene. Nonionic surfactants that comprise a mixture of R¹ and R² units preferably comprise from about 4 to about 12 ethylene units in combination with from about 1 to about 4 1,2-propylene units. The units may be alternating, or grouped together in any combination suitable to the formulator. Preferably the ratio of R¹ units to R² units is from about 4:1 to about 8:1. Preferably, one R² unit (i.e. 1,2-propylene) is attached to the nitrogen atom followed by the balance of the chain comprising from 4 to 8 ethylene units.

In the above formula, R³ is hydrogen, C₁-C₄ linear alkyl, C₃-C₄ branched alkyl, and mixtures thereof; preferably hydrogen or methyl, more preferably hydrogen. R⁴ is hydrogen, C₁-C₄ linear alkyl, C₃-C₄ branched alkyl, and mixtures thereof; preferably hydrogen. When m is equal to 2, n must be equal to 0 and the R⁴ unit is absent and is instead replaced by a —[(R¹O)ₓ(R²O)_{y}R³] unit. When m is 1, n is equal to 1. Preferably m is equal to 1 and n is equal to 1, resulting in one —[(R¹O)ₓ(R²O)_{y}R³] unit and R⁴ being present on the nitrogen. x is from 0 to about 50, preferably from about 3 to about 25, more preferably from about 3 to about 10. y is from 0 to about 10, preferably 0, however when y is not 0, it is from 1 to about 4. Preferably all of the alkyleneoxy units are ethyleneoxy units. Those skilled in the art of ethoxylated polyoxyalkylene alkyl amide surface active agents will recognized that the values for the indices x and y are average values and the true values may range over several values depending upon the process used to alkoxylate the amides. Suitable means for preparing the polyoxyalkylene alkyl amide surface active agents of the present invention can be found in “Surfactant Science Series”, Editor Martin Schick, Volume I, Chapter 8 (1967) and Volume XIX, Chapter 1 (1987).

Nonionic surfactants useful herein serve as viscosity/dispersability modifiers and include addition products of ethylene oxide and, optionally, propylene oxide, with fatty alcohols, fatty acids, fatty amines, etc. They are referred to herein as ethoxylated fatty alcohols, ethoxylated fatty acids, and ethoxylated fatty amines. Any of these alkoxylated materials can be used as a nonionic surfactant. In general terms, these nonionics, when used alone in the liquid compositions of the present invention are at a level of from 0% to 5%, preferably from 0.1% to 5%, more preferably from 0.2% to 3%.

Bleach

Bleaching agents can be included, preferably as a second cleaning ingredient, in the cleaning compositions of the present invention. They include hydrogen peroxide, PB1, PB4 and percarbonate with a particle size of 400-800 microns.

These bleaching agent components can include one or more oxygen bleaching agents and, depending upon the bleaching agent chosen, one or more bleach activators. When present oxygen bleaching compounds will typically be present at levels of from 0.1% to 30%, preferably 1% to 20%.

The bleaching agent component for use herein can be any of the bleaching agents useful for detergent compositions including oxygen bleaches as well as others known in the art. The bleaching agent suitable for the present invention can be an activated or non-activated bleaching agent.

One category of oxygen bleaching agent that can be used encompasses percarboxylic acid bleaching agents and salts thereof. Suitable examples of this class of agents include magnesium monoperoxyphthalate hexahydrate, the magnesium salt of meta-chloro perbenzoic acid, 4-nonylamino-4-oxoperoxybutyric acid and diperoxydodecanedioic acid. Such bleaching agents are disclosed in U.S. Pat. No. 4,483,781, U.S. patent application Ser. No. 740,446, European Patent Application 0,133,354 and U.S. Pat. No. 4,412,934. Highly preferred bleaching agents also include 6-nonylamino-6-oxoperoxycaproic acid as described in U.S. Pat. No. 4,634,551.

Another category of bleaching agents that can be used encompasses the halogen bleaching agents. Examples of hypohalite bleaching agents, for example, include trichloro isocyanuric acid and the sodium and potassium dichloroisocyanurates and N-chloro and N-bromo alkane sulphonamides. Such materials are normally added at 0.5-10% by weight of the finished product, preferably 1-5% by weight.

The hydrogen peroxide releasing agents can be used in combination with bleach activators such as tetraacetylethylenediamine (TAED), nonanoyloxybenzenesulfonate (NOBS, described in U.S. Pat. No. 4,412,934), 3,5,-trimethylhexanoloxybenzenesulfonate (ISONOBS, described in EP 120,591) or pentaacetylglucose (PAG) or Phenolsulfonate ester of N-nonanoyl-6-aminocaproic acid (NACA-OBS, described in WO94/28106), which are perhydrolyzed to form a peracid as the active bleaching species, leading to improved bleaching effect. Also suitable activators are acylated citrate esters such as disclosed in EP 624 154 and the unsymetrical acyclic imide bleach activator of the following formula as disclosed in the Procter & Gamble WO98/04664:

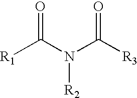

wherein R₁ is a C₇-C₁₃ linear or branched chain saturated or unsaturated alkyl group, R₂ is a C₁-C₈, linear or branched chain saturated or unsaturated alkyl group and R₃ is a C₁-C₄ linear or branched chain saturated or unsaturated alkyl group. Those bleach activators are generally used within the detergent compositions of the present invention at a level of 0.1-10%, preferably 0.5-5% by weight of the detergent composition.

Useful bleaching agents, including peroxyacids and bleaching systems comprising bleach activators and peroxygen bleaching compounds for use in detergent compositions according to the invention are described in our co-pending applications WO95/10592, WO97/00937, WO95/27772, WO95/27773, WO95/27774 and WO95/27775.

The hydrogen peroxide may also be present by adding an enzymatic system (i.e. an enzyme and a substrate therefore) which is capable of generating hydrogen peroxide at the beginning or during the washing and/or rinsing process. Such enzymatic systems are disclosed in EP 537 381.

Metal-containing catalysts for use in bleach compositions, include cobalt-containing catalysts such as Pentaamine acetate cobalt(III) salts and manganese-containing catalysts such as those described in EPA 549 271; EPA 549 272; EPA 458 397; U.S. Pat. No. 5,246,621; EPA 458 398; U.S. Pat. No. 5,194,416 and U.S. Pat. No. 5,114,611. Bleaching composition comprising a peroxy compound, a manganese-containing bleach catalyst and a chelating agent is described in the patent application No 94870206.3. The bleaching compounds can be catalyzed by means of a manganese compound. Such compounds are well known in the art and include, for example, the manganese-based catalysts disclosed in U.S. Pat. No. 5,246,621, U.S. Pat. No. 5,244,594; U.S. Pat. No. 5,194,416; U.S. Pat. No. 5,114,606; and European Pat. App. Pub. Nos. 549,271A1, 549,272A1, 544,440A2, and 544,490A1; Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂(ClO₄)₂, Mn^{IV}₄(u-O)₆(1,4,7-triazacyclononane)₄(ClO₄)₄, Mn^{III}Mn^{IV}₄(u-O)₁(u-OAc)₂₋(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof.

More preferred for use therein are the transition metal bleach catalysts being complexes of a transition metal and a cross bridged macropolycyclic ligands such as described in Procter & Gamble patent applications WO98/39405, WO98/39406 and WO98/39098. Most preferred is the Mn Complex Bleach Catalyst of the formula [Mn(Bcyclam)Cl₂] illustrated as:

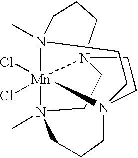

“Bcyclam” (5,12-dimethyl-1,5,8,12-tetraaza-bicyclo[6.6.2]hexadecane or 5,12-diethyl-1,5,8,12-tetraaza-bicyclo[6.6.2]hexadecane). Such transition -metal bleach catalyst can be prepared according to Procter & Gamble patent application WO98/39335 or according to J. Amer. Chem. Soc., (1990), 112, 8604. These bleach catalysts are generally encompassed in the detergent compositions of the present invention at a level of 0.0007-0.07%, preferably 0.005-0.05% by weight of the detergent compositions.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. These materials can be deposited upon the substrate during the washing process. Upon irradiation with light, in the presence of oxygen, such as by hanging clothes out to dry in the daylight, the sulfonated zinc phthalocyanine is activated and, consequently, the substrate is bleached. Preferred zinc phthalocyanine and a photoactivated bleaching process are described in U.S. Pat. No. 4,033,718. Typically, detergent compositions will contain about 0.025% to about 1.25%, by weight, of sulfonated zinc phthalocyanine.

Also suitable as bleaching species for the purpose of the present invention are a colour-safe bleach boosters that may be used in conjunction with a peroxygen source in a bleaching composition. The bleach booster is generally present in the detergent compositions at a level of from 0.01-10% and more preferably from 0.05-5% by weight of the composition. Bleach boosters to be included in the detergent compositions of the present invention comprise zwitterionic imines, anionic imine polyions having a net negative charge of from about −1 to about −3, and mixtures thereof.

Suitable imine bleach boosters of the present invention include those of the general structure:

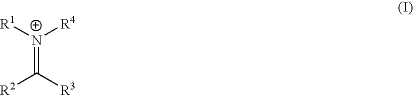

where R¹-R⁴ may be a hydrogen or an unsubstituted or substituted radical selected from the group consisting of phenyl, aryl, heterocyclic ring, alkyl and cycloalkyl radicals except that at least one of R¹-R⁴ contains an anionically charged moiety.

Preferred bleach boosters are the anionically charged moiety bonded to the imine nitrogen described in WO97/10323. Also preferred are the tri:cyclic oxaziridinium compounds described in U.S. Pat. No. 5,710,116 and the bleach boosters described in WO98/16614. These can be prepared in accordance with the method described in WO97/10323 and/or WO98/16614.

Also suitable are pre-formed peroxy Carboxylic acid, preferably used in conjunction with a suspending agent as described on page 21, line 21 to page 25, line 20 of WO01/00765 to The Procter & Gamble Company

Dual- or Poly- Functional Agents or Adjuncts

The present articles and compositions can additionally comprise at least about 0.0001%, when present, of a dual-functional agent having both cleaning and fabric care activity. For example, certain polymers can be useful to suspend soil and to provide a fabric care effect.

Optional Components

The fabric cleaning and care compositions of the present invention may contain one or more optional materials that improve the function of the essential fabric cleaning agent(s) or the fabric care active(s) or the appeal of the compositions to the consumer. These optional ingredients can include, solvents, stabilizers, aesthetic adjuncts, e.g., colorants; pH adjusting agents, fillers, surfactants, bleaches, effervescent agents and the like, can be optionally present in any of the inventive compositions. The compositions of the present invention may further comprise optional stabilizers, viscosity modifiers and/or suspension agents, amongst other materials. By way of example, where slightly water soluble or water insoluble components are used in the compositions, a stabilizer and/or suspension agent may be required. Where the rheological properties of the fabric cleaning and care compositions differ, it is anticipated that a viscosity modifier may be added to one or both of the compositions to achieve a desired pouring ratio.

Solvents

Water and/or solvents can in general be present or absent in the fabric cleaning or fabric care compositions of the present invention, however water and/or solvents are usually present at levels of at least about 0.01% to about 80%, or higher, in any of the compositions. Suitable solvents include ethanol, isopropanol, propylene glycol, hexylene glycol, 1,2-propanediol, 1,3-propanediol, propylene carbonate, 1,4 cyclohexane dimethanol, amongst others.

Stabilizer and Viscosity Modifiers

Stabilizers and viscosity modifiers suitable for use herein can be selected from thickening stabilizers, including gums and other similar polysaccharides, for example gellan gum, carrageenan gum, and other known types of thickeners and rheological additives. More preferably, the stabilizer is a crystalline, hydroxyl-containing stabilizing agent, more preferably still, a trihydroxystearin hydrogenated oil or a variation thereof. Crystalline, hydroxyl-containing stabilizing agents can be fatty acid, fatty ester or fatty soap water-insoluble wax-like substance. The crystalline, hydroxyl-containing stabilizing agents in accordance with the present invention are preferably derivatives of castor oil, especially hydrogenated castor oil derivatives, such as castor wax. The crystalline, hydroxyl-containing agent typically is selected from the group consisting of:

(i) R¹OCH₂CH(OR²)CH₂OR³

wherein R¹ is —C(O)R⁴, R² is R¹ or H, R³ is R¹ or H, and R⁴ is independently C₁₀-C₂₂ alkyl or alkenyl comprising at least one hydroxyl group;

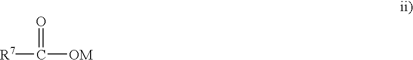

wherein:

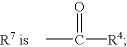

is as defined above in i); M is Na⁺, K⁺, Mg⁺⁺ or Al³⁺, or H; and mixtures thereof. Alternatively, the crystalline, hydroxyl-containing stabilizing agent may have the formula:

CH₃(CH₂)ₐCHOH(CH₂)ₓC(O)OCH₂CH(O(O)C(CH₂)_{y}CHOH(CH₂)_{b}CH₃)CH₂O(O)C(CH₂)_{z}CHOH(CH₂)_{c}CH₃

wherein: (x+a) is from between 11 and 17; (y+b) is from between 11 and 17; and (z+c) is from between 11 and 17. Preferably, wherein x=y=z=10 and/or wherein a=b=c=5.

Detail around a process for making these stabilizing agents can be found in U.S. Pat. No. 6,080,708, which is owned by The Procter and Gamble Company. Commercially available crystalline, hydroxyl-containing stabilizing agents include THIXCIN® from Rheox, Inc.

Other stabilizers useful herein include gum-type polymers (e.g. xanthan gum), polyvinyl alcohol and derivatives thereof, cellulose and derivatives thereof and tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de-branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, carboxymethylcellulose (CMC), dextrans, dextrins, ethylhydroxyethylcellulose (EHEC), guar, hydroxyethylcellulose (HEC), hydroxypropylcellulose (HPC), hydroxybutylcellulose (HBC), karaya, larch, methylcellulose (MC), tamarind, scleroglucan, xanthan, carboxymethylhydroxyethylcellulose (CMHEC), methoxypropyl methyl cellulose (MPMC), hexylcarboxymethyl cellulose, C₁₂-C₂₀ alkyl carboxymethylcellulose, methylhydroxyethylcellulose (MHEC), methylhydroxypropylcellulose (MHPC), hydroxyethylmethylcellulose (HEMC), hydroxypropylmethylcellulose (HPMC), hydroxybutylmethylcellulose (HBMC) and mixtures thereof.

Effervescing Agents

Another preferred optional ingredient will include effervescing agents. An effervescent system useful in the article of the present invention can be any suitable effervescent system known to those skilled in the art. For example, the effervescent system may comprise two components such as 1) a source of peroxide component such as hydrogen peroxide and 2) an effervescent agent-containing component such as catalase enzyme or a combination of components such as 1) an effervescent agent-containing component, such as bicarbonate and 2) an acid agent-containing component, such as citric acid. “Effervescence” as used herein includes, but is not limited to, the formation of gas, gas bubbles, foam, mousse, etc. from the effervescent system as described herein. Because it is desirable that the effervescent agent-containing component and the acid agent-containing component and/or the source of peroxide component remain separated from one another until effervescence is desired, it is anticipated that such effervescing agents will be contained in separate compartments of the container. Upon dispensing the agents shall be mixed together to generate the effervescence. Additional detail concerning the use of effervescent systems and their components may be found in WO 01/00765 De Buzzaccarini et al. filed Jun. 27, 2000.

Other Optional Components and Mixtures Thereof

Other optional components such as colorants, pH adjusting agents, fillers and bleaches amongst others, when used, are present at levels of from about 0.001% to about 80% of the composition.

Other Levels of Individual Ingredients

Unless otherwise specifically indicated, any essential or optional ingredient in the present articles and compositions can be present at widely ranging levels depending on the intended use. For example, as is widely known, enzymes or other catalytic materials can be useful and effective at levels as low as a fraction of a part per million by weight in a laundry composition. At the other extreme, water and/or fillers can also be present at very high levels. Thus, unless otherwise specifically indicated, any essential or optional ingredient herein can be used at levels ranging from one part per million by weight of a composition to 90% or higher.

Devices Useful in Conjunction with the Article: Dispensing Devices

The present invention is desirably used in conjunction with a dispensing device or article. For example, doses of fabric cleaning and/or fabric care compositions can be simultaneously or sequentially (preferably simultaneously) dispensed from the container of the present inventive article, into a dispensing cup. The dispensing cup can be any of many types known in the art, including those types having the ability to act as laundry pretreatment dispensers or as a “dispensing ball” which can be placed in a washing machine. Suitable dispensing balls are disclosed in U.S. Pat. No. 5,267,671, assigned to The Procter & Gamble Company and in EP 0 368 680 B1 assigned to Unilever. More recently developed pretreatment-type dispensers include those known as the “rollerball” type sold by The Procter & Gamble Company under the trade name “Kick”.

Kits

Preferred articles can be packaged in a kit, said kit additionally comprising a dispensing device, usage instructions, or combinations thereof.

Methods

The present invention has numerous method embodiments including a method of solving compatibility problems associated with storing and delivering a composition that simultaneously provides high quality fabric care benefits or both high quality fabric cleaning and fabric care benefits, from agents that are have measurably decreased stability or are incompatible in a combined composition.

The method comprises the steps of:

a) providing an article as described hereinabove;

b) dispensing the fabric care compositions or the fabric cleaning and fabric care compositions from said article so that there is effective mixing of the compositions; and

c) dispensing the mixed fabric care composition or the mixed fabric cleaning and care compositions into a laundry solution for use in laundering fabrics.

The method may also comprise providing means for generating a signal with effective mixing has been achieved. Such means includes the incorporation of effervescing agents in the respective compositions of the different compartments such that the mixed compositions generate a foam or mousse as mixing occurs. It is the observation of this foam generation or mousse that signals to a consumer that the compositions are thoroughly mixed and ready for dispensing in a laundry solution.

An alternative method comprises the steps of directing the compositions from the different compartments into a dispensing device wherein effective mixing of these compositions may be achieved, and subsequently dispensing the mixed compositions into a solution for use in laundering fabrics. In this alternative method it is anticipated that the compositions may be stored in separate containers prior to dispensing.

The present invention also provides a method of simultaneously solving compatibility problems while communicating to a consumer the presence of unconventional fabric care technology in a laundry product, said method comprising the steps of:

a) selecting at least one fabric care active having measurably decreased stability in, or poor compatibility in, a fabric care composition comprising already another fabric care active;

b) providing a laundry article for use in providing fabric care benefits to fabrics, said article comprising

a container having multi-compartments;

a fabric care composition in each compartment; and

providing instructions for use of the laundry article.

The present invention also provides a method of simultaneously solving compatibility problems while communicating to a consumer the presence of unconventional fabric care technology in a laundry product, said method comprising the steps of:

a) selecting at least one fabric care active having measurably decreased stability in, or poor compatibility in, a detergent composition comprising a cleaning agent—in a specific embodiment: other than a surfactant or bleach;

b) providing a laundry article for use in providing cleaning and fabric care benefits to fabrics, said article comprising

a container having multi-compartments;

a fabric cleaning composition having substantially all of said cleaning agent in a first compartment; and

a fabric care composition in at least one additional compartment, said fabric care composition having substantially all of said fabric care active; and

c) providing instructions for use of the laundry article.

In a preferred method, said instructions for use comprise an instruction to the consumer to cause the compositions to mix in a dispensing device non-integral with a laundry washing machine so that within said dispensing device, a signal of effective mixing can be observed. The method can further comprise the instructions of manually agitating said dispensing device for a period sufficient to observe at least one signal that mixing has been effected. Also encompassed is a method of using a laundry article as defined hereinabove to separate several fabric care actives or to separate a fabric care active from a fabric cleaning agent wherein said fabric care actives or said fabric care active and fabric cleaning agent are compatible in the sense that they can be mixed without chemical reaction or physical phase change occurring, wherein said article further comprises labeling means identifying the components in any of said multi-compartments, and whereby a consumer better understands the purpose and use of the different compositions of said article.

In other preferred methods, said fabric care active comprises a hydrolysable moiety; preferably said hydrolysable moiety is an ester.

In another method embodiment, the invention encompasses a method of use of a laundry article as defined hereinabove comprising:

a) pouring simultaneously the two compositions of the article of the present invention into a dispensing device, wherein said dispensing device is non-integral with a washing machine and enables the mixing of the two compositions;

b) observing at least one signal that mixing has been effective, wherein said signal is derived from chemical reaction or a physical-chemical system change such as selected from a color change, a change in volume, a change in viscosity, an effervescent effect, an odor change, an audible change (e.g., “popping”) a change in temperature, or combinations thereof; and

c) placing the dispensing device in a washing machine or laundry solution.

Use of the Compositions

The present articles, compositions and methods are typically used in or in conjunction with automatic washing machines, but it is also anticipated that they may also be used to advantage in pretreatment and/or hand wash applications. In the following examples, the number associated with each material represents the percentage by weight of the cleaning or fabric care composition.

In examples 1 to 8, for purposes of consistency Composition “A” is the composition containing the cleaning agent, and composition “B” is the composition containing the fabric care agent. Compositions A and B are separately prepared and each composition is placed into one of the compartments of a dual-chamber container having a general design and dimensions suitable for liquid detergent laundry products. However, the cleaning agents are preferably maintained in separate compartments prior to dispensing to achieve optimum stability.

All ingredients (including the fabric care actives) have good chemical and physical stability as formulated, and this would not have been possible by mixing all the ingredients together in a single composition.

### EXAMPLES 1 and 2

Examples 1 and 2 are liquid compositions. The fabric care active (Dimethyl ditallowacyloxyethyl or cationic silicone) is in one compartment, the cleaning agents are maintained in the 2 compartments prior to dispensing to achieve optimum stability.

| | 1 | | 2 | |
|---|---|---|---|---|
| | A | B | A | B |
| Alcohol ethoxylate (nonionic) | 15 | 5 | 10 | 10 |
| Alkyl amine oxide | 5 | — | — | 5 |
| Citric acid | — | 10 | 6 | — |
| Ethoxylated alkyl amine | 1 | — | 1 | — |
| Chelant | 0.4 | — | — | 0.4 |
| N, N-dimethyl N,N | — | 15 | — | — |
| di(tallowacyloxyethyl)ammonium | | | | |
| chloride | | | | |
| Cationic silicone | — | — | — | 5 |
| Protease enzyme | 0.10 | — | 0.74 | — |
| Amylase enzyme | 0.22 | — | 0.22 | — |
| Boric acid | 2 | — | 2 | — |
| Ethanol | — | 5 | — | — |
| Propanediol | 10 | — | 8 | — |
| Sodium cumene sulfonate | 2 | 2 | — | 2 |
| Sodium hydroxide | — | to pH | — | to pH |
| | | 3.0 | | 4.0 |
| Monoethanolamine | to pH | — | to pH | — |
| | 7.5 | | 8.0 | |
| Perfume/minors | 1.5 | 1.5 | — | 0.6 |

| | | |
|---|---|---|
| Water | Balance | Balance |

### EXAMPLE 3

Example 3 is a liquid composition generating a mousse upon mixing the two parts. The fabric care active (Methyl hydroxyethyl di-canolacyloxyethyl) is in one compartment, the cleaning agents are maintained in the 2 compartments prior to dispensing to achieve optimum stability.

| | A | B |
|---|---|---|
| Alcohol ethoxylate (nonionic) | — | 17 |
| N-(C10 alkylamidopropyl) N,N- | — | 3 |
| dimethylamine | | |
| Citric acid | — | 15 |
| Polyethylenimine ethoxylate | | 1.5 |
| Ethoxylated tetraethylene | — | 0.5 |
| pentamine | | |
| Chelant | — | 0.3 |
| N-methyl N-(2-hydroxyethyl) N,N- | — | 12 |
| di (canolacyloxyethyl) ammonium | | |
| chloride | | |
| Sodium bicarbonate | 6.5 | — |
| Protease enzyme | 0.5 | — |
| Amylase enzyme | 0.22 | — |
| Boric acid | 2 | — |
| Ethanol | — | 5 |
| Propandiol | 7.5 | — |
| Sodium cumene sulfonate | 2 | 2 |
| Sodium hydroxide | — | to pH 3.0 |
| Monoethanolamine | to pH | — |
| | 8.5 | |
| Perfume/minors | 0.3 | 1.5 |

| | |
|---|---|
| Water | Balance |

### EXAMPLE 4

Example 4 is a liquid composition generating a mousse upon mixing the two parts. The fabric care active (methyl-N-(2-hydroxyethyl)-N,N-di (tallow acyloxyethyl) ammonium methyl sulfate) is in one compartment, the cleaning agents are maintained in the 2 compartments prior to dispensing to achieve optimum stability.

| Material | A | B |
|---|---|---|
| Alkyl ethoxylate | 14.1 | 17.5 |
| Alkyl amine oxide | 3.6 | 2.5 |
| Citric acid | — | 3.2 |
| Ethoxylated alkyl amine | 1.2 | — |
| (quaternized) | | |
| Polyethyleneimine ethoxylate | 0.6 | — |
| Chelant | — | 0.3 |
| Monoethanolamine | — | 3.5 |
| Sulfuric acid | — | 0.5 |
| Methyl-N-(2-hydroxyethyl)-N,N-di | — | 13.4 |
| (tallow acyloxyethyl)ammonium | | |
| methyl sulfate | | |
| Cationic silicone | 1.7 | — |
| Protease | 0.03 | — |
| Amylase | 0.1 | — |
| Cellulase | 0.01 | — |
| Boric acid, | 2.3 | — |
| monoethanolammonium salt | | |
| Calcium Chloride | 0.02 | — |
| Propandiol | 7.2 | — |
| Cyclohexanedimethanol | 2.0 | 9.4 |
| Hydrogenated castor oil | 0.8 | — |
| Hydrogen peroxide | — | 2.0 |
| Catalase (Oxygone 400) | 0.4 | — |
| Trimethoxy benzoic acid | — | 0.1 |
| Dyes | — | 0.001 |
| Perfume | 2.0 | — |
| Water | Bal | Bal |

### EXAMPLE 5

In Example 5, the fabric care active (Carezyme®) is incorporated separately from the protease enzymes for improved stability.

| | A | B |
|---|---|---|
| Alcohol ethoxylate (nonionic) | 8 | 3 |
| Linear alkylbenzene sulphonate | 17 | — |
| Citric acid | 3.5 | — |
| Polyethylenimine ethoxylate | 0.8 | — |
| Ethoxylated alkyl amine | 0.5 | — |
| Chelant | 0.3 | — |
| C12-14 fatty acid | 6.5 | — |
| Protease enzyme | 0.7 | — |
| Carezyme (cellulase enzyme) | — | 0.3 |
| Boric acid | 0.8 | — |
| Ethanol | 5 | — |
| Propandiol | 5.5 | — |
| Sodium cumene sulfonate | 2 | 2 |
| Monoethanolamine | to pH 7.0 | to pH 7.0 |
| Perfume/minors | 0.5 | 0.1 |
| Water | Balance | |

### EXAMPLE 6

In Example 6, the fabric care active (hectorite clay) provides a much better fabric softness performance when delivered separately from the fabric cleaning composition.

| | A | B |
|---|---|---|
| Alkylsulfate | 12.4 | — |
| Alkyl ethoxysulfate | 2.4 | — |
| C18-18 fatty acid | 6.5 | — |
| Linear alkylbenzene sulphonate | 6 | — |
| Citric acid | 1.5 | — |
| Alkyl trimethyammonium chloride | 0.75 | — |
| Chelant | 0.3 | — |
| C12-14 fatty acid | 6.5 | — |
| Protease enzyme | 0.7 | — |
| Amylase enzyme | 0.4 | — |
| Hectorite clay | — | 3.3 |
| Boric acid | 0.8 | — |
| Propandiol | 8 | — |
| Sodium hydroxide | to pH 8.0 | — |
| Perfume/minors | 1.5 | 0.1 |
| Water | balance | |

### EXAMPLES 7 and 8

In Examples 7 and 8 the fabric care actives (imidazole/epichorohydrin copolymer, Polyvinylpyridine N-oxide and carboxymethyl cellulose) are easier to stabilize and provide better performance when they are incorporated separately from the fabric cleaning agents.

| | 7 | | 8 | |
|---|---|---|---|---|
| | A | B | A | B |
| Alcohol ethoxylate | 13 | 0.5 | 4.5 | — |
| Linear alkylbenzene sulphonate | 7 | — | 12.2 | — |
| Citric acid | 3.5 | — | 2.7 | — |
| Polyethylenimine ethoxylate | 1.2 | — | — | — |
| Ethoxylated alkyl amine | 0.8 | — | 1.2 | — |
| Chelant | 0.3 | — | 0.2 | — |
| C12-14 fatty acid | 7.1 | — | 5.5 | — |
| Protease enzyme | 0.7 | — | 0.55 | — |
| Amylase enzyme | 0.4 | — | 0.2 | — |
| Boric acid | 1.8 | — | 2.5 | — |
| Ethanol | 3.5 | — | 2.4 | 2 |
| Propandiol | 8.5 | — | 7.5 | — |
| Sodium cumene sulfonate | 2 | 1.5 | 1.5 | 1.0 |
| Brightener | 0.2 | — | 0.2 | — |
| Imidazole/epichlorohydrine | — | 0.8 | — | — |
| copolymer | | | | |
| Polyvinylpyridine N-oxide | — | 0.3 | — | — |
| Carboxymethylcellulose | — | — | — | 0.5 |
| Monoethanolamine | to pH | to pH | to pH | to pH |
| | 7.0 | 7.0 | 7.0 | 7.0 |
| Perfume/minors | 0.5 | 0.1 | 0.8 | 0.3 |

### EXAMPLE 9

Two fabric care compositions are formulated with fabric care actives in both compartments, which are physically not highly stable with each other. Compartment B includes e.g. Cartafix®, a polymeric dye fixative that requires high ionic strength, which are physically not highly stable with the softening ingredient of the fabric care composition of compartment A.

| | A | B |
|---|---|---|
| N,N,-di-(canolyl-oxyethyl)-N- | 25 | — |
| methyl N-(2 hydroxyethyl) | | |
| ammonium methylsulfate | | |
| Hexylene glycol | 1.8 | 2.0 |
| Ethanol | 1.8 | — |
| Trimethyl pentanediol | 12 | — |
| Bis-dimethylamino propylamine | — | 4.5 |
| Magnesium chloride | 0.02 | 2.0 |
| 1-hydroxyethane-1,1- | — | 0.5 |
| diphosphonic acid | | |
| Cationically modified | — | 3.5 |
| polyacrylamide: | | |
| acrylamide/dimethylamimo | | |
| ethylacrylate methochloride | | |
| Cartafix ® | — | 2.0 |
| Hydrochloric acid | To pH 3.0 | To pH 3.0 |
| Perfume | 2.5 | — |
| Dyes and minors | 0.2 | 0.2 |

| | |
|---|---|
| Water | Balance |

Other Advantages, Other Embodiments and Ramifications

The present invention has numerous advantages, other embodiments and ramifications. For example the invention is especially effective to deliver superior fabric care or combinations of gentle cleaning and fabric softness and to combine effective cleaning with fabric restorative technology suitable for treating by hand or in a washing machine such fabrics as those made from or having wool, silk, delicate colors and/or elastomeric synthetic threads, filaments or yarns.

The article of the invention can be used with or without an effervescent or “mousse” signaling system, and the separate compositions can be colored or colorless, opaque, pearlescent, opalescent, transparent, or translucent.

It is often found desirable to communicate differences in the technology contained in the different compositions of the present article by accentuating differences in their visual appearance types, for example a creamy lotion-like composition might be used in one compartment having, for example, the fabric care actives, while a translucent and colored, e.g., blue, red, green, yellow form might be used for the fabric cleaning composition as incorporated into another compartment of the article. Various visual indicators may be associated with the respective compositions to facilitate identification thereof by the consumer.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A laundry article for providing fabric care benefits to fabrics, the article comprising:
a) a container having at least two compartments; and
b) a fabric care composition in at least one compartment, said fabric care composition having at least one fabric care active selected from the group consisting of fabric softeners, textile color care agents, textile property modifiers, textile odor modifiers, and mixtures thereof.

2. The laundry article according to claim 1, for providing cleaning benefits in addition to fabric care benefits to fabrics, the article comprising:
b) said fabric care composition in a first compartment; and
c) a fabric cleaning composition in a second compartment, said fabric cleaning composition having at least one fabric cleaning agent.

3. The laundry article according to claim 2, wherein said fabric cleaning agent is not a detersive surfactant or a bleach.

4. The laundry article according to claim 1, wherein said fabric care composition further comprises a fabric cleaning agent.

5. The laundry article of claim 2, wherein the fabric cleaning and/or fabric care compositions are in the form of a liquid.

6. The article of claim 5, wherein each of said liquids has a viscosity in the range from about 1 cps to about 3000 cps measured at 20 s⁻¹ and 20° C.

7. The article of claim 1, wherein said container is free-standing.

8. The article of claim 1, wherein said container has one or more openings for dispensing said compositions.

9. The article of claim 1, wherein said fabric softener is selected from the group consisting of organic fabric softeners, inorganic fabric softeners and mixtures thereof and/or hybrid organic-inorganic fabric softeners.

10. The article of claim 9, wherein said organic fabric softeners is selected from the group consisting of quaternary nitrogen-containing organic fabric softeners free from ester and/or amide moieties; quaternary nitrogen-containing organic fabric softeners comprising ester and/or amide moieties; quaternary-nitrogen-free organic fabric softeners and mixtures thereof; preferably is a quaternary nitrogen-containing organic fabric softeners comprising ester moieties.

11. The article of claim 9, wherein said inorganic fabric softener comprises a smectite clay, preferably a hectorite clay.

12. The article of claim 1, wherein said textile color care agent is selected from the group consisting of dye fixatives, dye transfer inhibitors, color maintenance agents, whiteness enhancers, anti-fading agents including bleach scavengers and/or antioxidants, color appearance restoration agents [non-chelants], brightness restoration agents, UV protection agents for fabrics, sun fade inhibitors, anti-fading agents, and mixtures thereof.

13. The article of claim 1, wherein said textile property modifier is selected from the group consisting of bodying agents, fabric drape and form control agents, smoothness agents, static control agents other than fabric softeners inherently possessing static control ability, wrinkle control and/or ironing aid agents, finishing agents, fabric integrity agents, fabric anti-abrasion agents, fabric anti-wear agents, humectants, lubricants, pill removal agents, insect repellents, mite control agents, non-bleaching fabric sanitizers, anti-bacterial agents, antiviral agents, anti-fungal agents, flame retardants and mixtures thereof.

14. The article of claim 1, wherein said textile odor modifier is selected from the group consisting of perfumes, odor enhancers, malodor control agents and mixtures thereof.

15. The article of claim 14, wherein the perfume is a pro-perfume, substantive perfume, or a perfume combined with a perfume carrier.

16. The article of claim 2, wherein the fabric cleaning and/or fabric care compositions further comprises a stabilizer.

17. The article of claim 2, wherein the fabric cleaning and/or fabric care compositions further comprises a viscosity modifier.

18. The article of claim 1, wherein the compositions of a first and a second compartment further comprises at least one signal generating agent, wherein the signal generation agent generates a signal upon effective mixing of said compositions.

19. The article of claim 18, wherein said signal is a color change, a change in volume, a change in viscosity, the generation of effervescence or foam, an odor change, a change in temperature or combinations thereof.

20. The article of claim 1, wherein at least one of the compartments has dispensing means for regulating the flow of the composition from the compartment.

21. The article of claim 2, wherein said fabric cleaning composition and/or fabric care composition further comprises at least one dual-functional agent having both cleaning and fabric care activity.

22. The article of claim 1, further comprising a set of instructions associated with the container concerning the use of the fabric cleaning and/or care compositions.

23. The article of claim 22, wherein the instructions comprise an instruction to the consumer to mix the compositions and to observe a signal that effective mixing of the compositions has been achieved before dispensing the compositions.

24. A method for delivering a composition that provides fabric care benefits or that simultaneously provides both high quality fabric cleaning and fabric care benefits from agents that are have measurably decreased stability or are incompatible in a combined composition, the method comprising the steps of:
a) providing an article according to claim 1;
b) dispensing the compositions from at least a first and second compartment so that the compositions intimately mix; and
c) dispensing the mixed compositions into a laundry solution for use in laundering fabrics.

25. The method of claim 24, wherein the compositions are dispensed into a dispensing device in which effective mixing of the compositions may be achieved before dispensing the mixed compositions into a solution for use in laundering fabrics.

26. The method of claim 24, wherein a signal is generated when effective mixing of the compositions from at least a first and second compartment has been achieved, said signal being a color change, a change in volume, a change in viscosity, the generation of effervescence or foam, an odor change, a change in temperature, or combinations thereof.

27. The method of claim 26, wherein the mixed compositions are dispensed into a laundry solution by a consumer after observing said signal.

28. A method of simultaneously solving compatibility problems and of communicating to a consumer the presence of unconventional fabric care technology in a laundry product, said method comprising:
a) selecting at least one fabric care active having measurably decreased stability in, or poor compatibility in a fabric care or detergent composition;
b) providing a laundry article for use in providing cleaning and/or fabric care benefits to fabrics, said article comprising
a container having multiple compartments;
a fabric care composition having the fabric care active of a) in a first compartment; and
a fabric cleaning composition having an essential cleaning agent in a second compartment or a fabric care composition having another fabric care active than in a) in a second compartment; and
c) providing a set of instructions in association with said article concerning the use of said article.

29. The method of claim 28, wherein said instructions for use comprise an instruction to the consumer to combine the compositions in a dispensing device.

30. The method of claim 29, wherein set of instructions comprises an instruction to the consumer to mix the fabric care and fabric cleaning compositions for a period sufficient to observe a signal that mixing has been effected.

31. The method according to claim 30, wherein the combined compositions produce a signal of effective mixing that can be observed, wherein said signal is derived from chemical reaction or a physical-chemical system change, that occurs upon effective mixing.

32. The method of claim 30, wherein said signal is a color change, a change in volume, a change in viscosity, an effervescent or foaming effect, an odor change, or combinations thereof.

33. A method of laundering fabrics, the method comprising the steps of:
a) combining two compositions that are at least partially incompatible and waiting for a signal that mixing has been effected;
b) dispensing the combined composition in a laundry solution; and
c) immersing the fabrics in the laundry solution.

34. A laundry kit comprising the article of claim 1 and a dispensing device for mixing the fabric cleaning and fabric care compositions and dispensing the mixture into a laundry solution.
